(19) United States
(12) Patent Application Publication
(10) Pub. No.: US 2025/0018365 A1
(43) Pub. Date: Jan. 16, 2025

(54) ACTIVATED FUSED CARBON MONOLITHS

(71) Applicant: CARBON HOLDINGS INTELLECTUAL PROPERTIES, LLC, Ranchester, WY (US)

(72) Inventors: Charles Agee Atkins, Sheridan, WY (US); Charles S. Hill, Sheridan, WY (US)

(21) Appl. No.: 18/765,115

(22) Filed: Jul. 5, 2024

Related U.S. Application Data
(60) Provisional application No. 63/512,882, filed on Jul. 10, 2023.

(51) Int. Cl. B01J 20/20; B01D 53/02; B01D 53/26; B01J 20/30; B01J 20/34; C02F 1/28

(52) U.S. Cl. CPC B01J 20/20; B01D 53/02; B01D 53/261; B01J 20/3078; B01J 20/3085; B01J 20/3416; B01J 20/3441; C02F 1/283; B01D 2257/504

(57) ABSTRACT

A carbon monolith can include a plurality of carbon fibers fused together to form the carbon monolith. The plurality of carbon fibers are melt blown carbon fibers fused together at contact points. Each carbon fiber of the plurality of carbon fibers comprises a longitudinal resistivity of between about 1.5 μΩm and about 20 μΩm.

### CROSS-REFERENCE TO RELATED APPLICATIONS

This application claims priority to U.S. Provisional Application No. 63/512,882, filed 10 Jul. 2023, entitled “ACTIVATED FUSED CARBON MONOLITHS”, the entire disclosure of which is hereby incorporated by reference.

### FIELD

The described embodiments relate to carbon monoliths for use in a variety of different applications, such as filtration, sorbents, gas storage, and carbon dioxide capture. More particularly, the present embodiments relate to carbon monoliths and their properties and applications.

### BACKGROUND

Carbon monoliths are a unitary structure formed from carbon, or unitary structures that have a surface including carbon. Such monoliths may have an activated carbon surface and may be a solid structure or have one or more internal channels with high surface area. Activated carbon monoliths have a wide variety of uses in a gas and liquid phase adsorption, as well as catalyst applications and as electrode materials. Filtering application and gaseous storage may use an activated carbon monolith, and such applications may include at least, dehumidifying and purifying air; capturing, concentrating, and sequestering gases; and capturing, concentrating, and separating volatile organic compounds.

Activated carbon monoliths have traditionally been manufactured by assembling chopped carbon fibers with a phenolic or polyvinylidene chloride (PVDC) binder. The chopped carbon fibers and the binder undergo various degrees of compression and heat to produce activated carbon monoliths of various densities, structural features, and pore volume properties.

### SUMMARY

In at least one example, a method for separating components of a fluid stream includes making an activated carbon fiber, forming a carbon monolith by fusing a plurality of activated carbon fibers together, disposing the carbon monolith within a fluid stream, and capturing at least one component of the fluid stream with the carbon monolith.

In one example, making the activated carbon fiber includes a physical activation or a chemical activation. The physical activation can include pyrolizing the carbon fiber to between about 600° C. and about 900° C. The chemical activation can include treating the carbon fiber with a chemical activation agent and heating to a temperature of between about 450° C. and about 700° C. In one example, the chemical activation agent comprises at least one of a phosphoric acid, sulfuric acid, or zinc chloride. In one example, the carbon monolith is configured to adsorb aqueous greenhouse gases from wastewater. In one example, the carbon monolith is configured to dehumidify air. In one example, the carbon monolith is configured to adsorb air contaminants. In one example, the carbon monolith is configured to adsorb carbon dioxide.

In some examples, the method for separating components of a fluid stream further includes desorbing the component from the carbon monolith. In one example, desorbing the component includes inducing an electrical current stimulated desorption. In one example, the electrical current includes between about 0.1 amp and about 1 amp at a set voltage of between about 1V and about 10V. In some examples, desorbing the component includes applying varying frequency microwaves to the carbon monoliths.

In some examples, a method of storing a gas can include disposing a plurality of activated carbon fibers fused together to form the carbon monolith within a storage vessel and filling the storage vessel with a gas. In at least one example, the carbon monolith adsorbs at least a portion of the gas. In some examples, the plurality of carbon fibers of the carbon monolith are randomly oriented. In some examples, the gas can include at least one of hydrogen, methane, carbon dioxide, or propane. In an example, the carbon monolith can be configured to adsorb a specific element. In some examples, the storage vessel can include a maximum allowable operating pressure between about 50 psi and about 1,000 psi. In an example, the carbon monolith is configured to delay the release rate of the gas from the storage vessel.

In at least one example, a carbon monolith can include a plurality of carbon fibers fused together to form the carbon monolith. The plurality of carbon fibers can be melt blown carbon fibers fused together at contact points without the use of a binder. In some examples, each carbon fiber of the plurality of carbon fibers has a longitudinal resistivity of between about 1.5 μΩm and about 20 μΩm. In one example, the carbon monolith does not have a binder to bind the melt blown carbon fibers. In one example, the carbon fibers are fused together to form the carbon monolith and are randomly oriented.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 illustrates a flow chart of a method for separating components of a fluid stream according to one embodiment of the present disclosure.

FIG. 2 illustrates a flow chart of a method for storing a gas according to one embodiment of the present disclosure.

FIG. 3 illustrates a scanning electron microscope (SEM) image of melt blown carbon fibers from a coal based pitch forming a carbon monolith at 144 times magnification according to one embodiment of the present disclosure.

### DETAILED DESCRIPTION

The present description provides examples, and is not limiting of the scope, applicability, or configuration set forth in the claims. Thus, it will be understood that changes can be made in the function and arrangement of elements discussed without departing from the spirit and scope of the disclosure, and various embodiments can omit, substitute, or add other procedures or components, as appropriate. For instance, methods described can be performed in an order different from that described, and various steps can be added, omitted, or combined. Also, features described with respect to some embodiments can be combined in other embodiments.

Carbon monoliths are a unitary structure formed from carbon or structures that have a surface including carbon. Such monoliths may have an activated carbon surface and may be a solid structure or can have one or more internal channels with high surface area. A gram of activated carbon can have a surface area in excess of 500 m² (5,400 sq. ft.), with 3,000 m² (32,000 sq. ft.) being readily achievable. Activated carbon monoliths can have a wide variety of uses in a gas and liquid phase adsorption, as well as gas storage and also as electrode materials. In gas phase adsorption applications, activated carbon monoliths may be used in electrical swing adsorption (ESA) process, where the monolith can be quickly regenerated by application of electric current. For liquid phase applications, activated carbon monoliths may offer high efficiency adsorption in a flow through configuration.

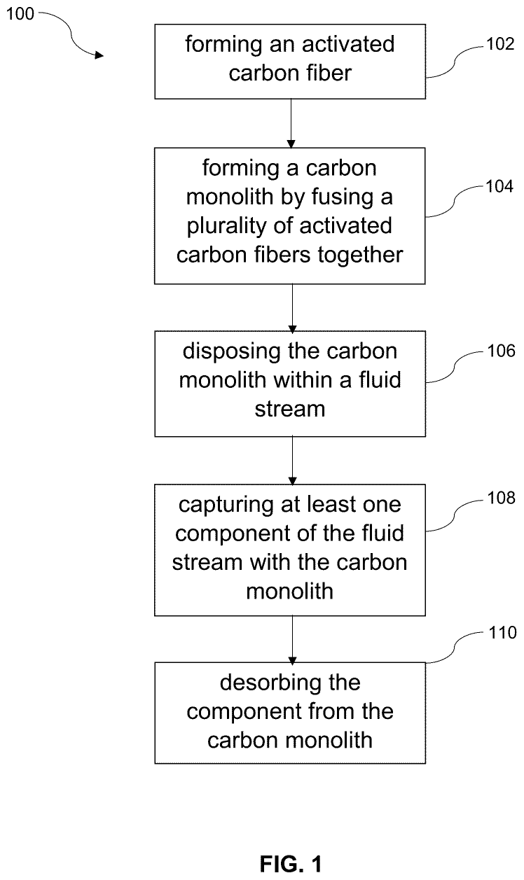

Activated carbon can be used to filter and purify numerous substances. Activated carbon is a porous carbon with a high surface area that can be suited for air purification, water treatment, and/or sewage treatment. Referring to FIG. 1, in some examples, a method 100 for separating components of a fluid stream can include an act 102 of forming an activated carbon fiber. Several raw materials can be used to initiate an activated carbon, including raw coal. In some examples, raw coal can include other substances and impurities, such as organic matter, rare earth elements, or other material that fills microscopic holes, or pores, in the carbon.

The activated carbon monolith can be made with activated carbon particles chosen for their activity, and also selectivity for a given use. The activated carbon monolith of a known composition can be expected to have a predictable activity and selectivity based on the particular activated carbon particles used. In some examples, making the activated carbon fiber can include a physical activation or a chemical activation. A physical activation process can involve carbonization of a carbonaceous material to eliminate the bulk of volatile matter, followed by activation of the resulting char in the presence of activating agents, such as CO₂, steam, air, or some combination of these agents, resulting in the release of carbon oxides from the carbon surface. In some examples, physical activation can include pyrolizing the carbon fiber to between about 600° C. and about 900° C. The physical activation can include a complex, heterogeneous process involving the transport of gas agents to the sample surface; the diffusion into the pores, sorption on the pore surface, and reaction with carbon component of these agents; desorption of the reaction products, and their diffusion into the atmosphere.

In some examples, the activation can include a chemical activation. Chemical activation can include treating the carbon fiber with a chemical activation agent and then heating the carbon fiber to a temperature of between about 450° C. and about 700° C. During chemical activation, the raw material is impregnated with certain chemicals such as zinc chloride (ZnCl₂), sodium hydroxide (NaOH), potassium hydroxide (KOH), sulfuric acid (H₂SO₄) and/or phosphoric acid (H₃PO₄), and then heat treated in an inert atmosphere through a one-step process. Compared with chemical activation, the main advantage of physical activation is that it avoids the mixing of impurities derived from the chemical activating agent. Furthermore, chemically activated carbon has a considerable inorganic content, which may lead to environmental contamination. Hence, physical activation is more favorable than chemical activation in terms of environmental safety because no chemical reagents are used. However, chemical activation is generally more economical because lower temperatures are used.

In addition, the activated carbon particles of the present application are fused. The method 100 also includes act 104 of forming a carbon monolith by fusing a plurality of activated carbon fibers together. In other words, a plurality of melt blown carbon fibers can be fused together at contact points between adjacent melt blown carbon fibers. In some examples, a single carbon fiber may fuse to multiple different adjacent carbon fibers. Due to the random orientation of each carbon fiber, each carbon fiber may physically contact multiple other carbon fibers. Due to the plurality of nonwoven fiber mats, the carbon monolith can include one or more internal channels with high surface area within the carbon monolith.

The fusing of the carbon fibers may occur during an oxygen stabilization process. During the oxygen stabilization process the carbon fibers self-fuse to other other carbon fibers at contact points between adjacent fibers. The fusing of the carbon fibers may occur at a number of different times during the manufacturing process. For example, the carbon fibers may be fused after the nonwoven fiber mat is formed following melt blowing. In another example, the carbon fibers may be fused after stacking the plurality of nonwoven fiber mats. In another example, the carbon fibers may be fused after compressing the stacked plurality of nonwoven fiber mats to form the monolithic structure of the carbon monolith. In some examples the carbon fibers are fused one or more times along the manufacturing process. The fusing of the carbon fibers enables the carbon monolith to be formed. In contrast with the prior art, the carbon monolith is formed from a plurality of carbon fibers without the use of a binder agent, such as a resin binder, a phenolic bind, or a PVDC binder.

After the monoliths are formed, the activated carbon fiber can be disposed in systems. The character of the monoliths can direct the use, in some examples. For example, the diameter of the pores on and inside activated carbon will make a significant difference in how the materials perform. Pore diameter can determine the specific use of a carbon, as activated carbon with more micropores (smaller pores) can be effective for removing low concentrations of organic matter found in water. Activated carbon with both small and large pores are very versatile and can be used to remove both chlorine and a wide variety of organic matter at the same time.

In some examples, depending on the raw material, the activation process, and other factors, the surface area will vary, giving the activated carbon fiber more or less adsorption potential. Density will affect the volume activity. Generally, a higher density will indicate a higher-quality activated carbon. There are numerous ways to define density, including real density, which is the density excluding the voids of the material, as well as particle density, which is the measured density of the carbon particles alone. The density measurements provide specific data on activated carbon performance. Also, ash content can be an important measurement for activated carbon and can drastically change the effectiveness and specific use for the product. Ash in the activated carbon reduces the speed and reliability of reactivation and metal oxides can be released from charcoal with high ash content, resulting in discoloration when used to purify water. The size of granular activated carbon (activated carbon that is in the form or a powder or fine grains) is measured using a mesh system. According to this methodology, the activated carbon is measured by shaking a sample of the granulated carbon through a series of fine sieves or screens with small holes between the wires. Using a system that measures how much of the carbon passes through the screens, the activated carbon can be measured for general size.

In some examples, the method 100 can include an act 106 of disposing the carbon monolith within a fluid stream. The carbon fused monoliths can act as an adsorbent to remove smaller range of particle sizes for items like gases, chemicals and VOCs. Act 108 includes capturing at least one component of the fluid stream with the carbon monolith. For example, the carbon monolith can be configured to adsorb aqueous greenhouse gases from wastewater. Both industrial and municipal wastewater can be treated to remove impurities and make it potable, creating clean water for a number of different applications. In this process, activated carbon is usually used in the final stages after processes like sedimentation and flocculation. After all the suspensions have been removed, the fluid stream can include water passed through the activated carbon monolith. Impurities that fail to be adsorbed previously, can be adsorbed. The resulting clean water can be used for drinking or as service water in swimming pools and aquariums. The intended use of the treated water dictates the activated carbon filtration system that will be used.

In some examples, chlorine is used widely in the disinfection of public water supplies as it is a powerful germicide. In large quantities, however, it can cause problems when consumed and can leave water with an undesirable taste. The activated charcoal monoliths can be effective in the removal of chlorine from water. In some examples, flow rates of between 2 to 3 GPM/ft³ can be used to extend the residence time spent in contact with the carbon. The residence time is directly proportionate to the amount of chorine removed. In some examples, several activated carbon filters are connected in series, because then a maximum load in the first filter can be achieved. Impurities which cannot be adsorbed in the first filter anymore are adsorbed in the next filters. Micropollutants in wastewater present environmental and human health challenges. In some examples, the carbon monoliths can effectively remove organic micropollutants. The activated carbon captures the targeted components for removal, rendering the water sufficient for discharge or its intended reuse application.

In some examples, the fluid stream of act 106 can include an air stream. The carbon monolith can be configured to dehumidify air in some examples. For example, the activated carbon can operate as a dehumidifier by absorbing excess moisture in the air. The absorbent nature of the carbon can trap and hold water molecules. As such, an activate carbon monolith can be used in filter materials, and/or can be placed in air conditioning ducts to dehumidify the air passing therethrough.

In some examples, the carbon monolith can be included to adsorb air contaminants. Similar to dehumidification, contaminates can be trapped in the pores and later safely released. For example, the contaminants can adsorb to the surface of the carbon monolith and can be removed from the water or air. The activated carbon can treat a wide range of contaminant vapors including radon and contaminants dissolved in groundwater, such as fuel oil, solvents, polychlorinated biphenyls (PCBs), dioxins, and other industrial chemicals, as well as radon and other radioactive materials. It even removes low levels of some types of metals from groundwater. In some examples, the carbon monolith can be configured to adsorb carbon dioxide.

For separating carbon dioxide (CO₂) from a gas stream, for example, the gas stream can include a flue gas from a coal fired power plant, a natural gas fired power plant, or a refinery. The impurities that are removed from the CO₂ containing gas stream can include, for example, hydrocarbons, oxygen, nitrogen, argon, sulfur oxides, mercury, or other compounds. In some examples, a CO₂ separation system can include at least one bed of carbon monolith that removes the CO₂ from the fluid stream by adsorption, or by absorption with a non-aqueous solvent. Both physical or reactive absorption and adsorption can be used. The pressure of the fluid stream can include ranges from, for example, about 15 psi to about 400 psi. In some examples, the CO₂ removal system can include additional beds for removal of other components in the fluid stream such as moisture, residual sulfur oxides, and mercury.

Activated carbon can capture CO2 because it exhibits a large surface area per unit volume and submicroscopic pores, in which contaminant adsorption occurs. Moreover, activated carbon is stable under acidic and basic conditions. It is also cost effective because it can be regenerated and thus suitable for organic compound removal. The surface chemistry of an adsorbent plays an important role in determining its adsorption properties. A porous surface indicates more active sites and yields higher CO₂ adsorption capacity.

In some examples, the carbon monolith can be doped with materials to improve capture of the CO₂. For example, CO₂ is weakly acidic and, upon dissolution in water, produces a weak acid, H₂CO₃ or carbonic acid. With an increase in pH, H₂CO₃ can further dissociate and produce conjugate anions (HCO₃⁻ and CO₃²⁻), which are referred to as alkalinity (i.e., weak base) due to their acid-neutralizing capacity. The use of OH⁻ as the counterion for Polyam-N—Cu²⁺ can lead to an irreversible uptake of CO₂ from the atmosphere. The atmospheric CO₂ capture capacity of 5.1 mol of CO₂/kg of Polyam-N—Cu²⁺ is nearly two to three times greater than most of other DAC sorbents reported to date for direct CO₂ capture.

In some examples, the method 100 can also include act 110. Act 110 includes desorbing the component from the carbon monolith. Activated carbon which has reached its working capacity can be either regenerated for re-use or disposed and replaced with fresh carbon. Regeneration is the reversal of adsorption primarily manifest as desorption. In some examples, desorption can include a temperature swing regeneration, a pressure swing regeneration, an electrical current stimulated desorption, or combinations thereof.

For temperature desorption, the desorption takes place at a temperature much higher than adsorption. The elevated temperature shifts the adsorption equilibrium resulting in contaminant desorption and regeneration of the adsorbent bed. To remove the thermally desorbed contaminant from the bed, a purge or sweep gas is utilized. A cooling step then returns the bed to its adsorption temperature. Temperature swing regeneration is characterized by high capacities at low concentrations. This results in relatively long cycle times (hours to days). Most applications are for systems with low contaminant concentrations (purification).

In pressure swing regeneration, desorption occurs at a pressure much lower than adsorption. This pressure reduction shifts the adsorption equilibrium resulting in contaminant desorption and regeneration of the adsorbent bed. A purge step can also be utilized to increase contaminant recovery during this method of desorption. No heating or cooling steps are required for this method. Most pressure swing regeneration cycles are characterized by low capacities at high concentrations. This requires that cycle times be short (seconds to minutes). Major uses for this process include purification and feed systems where contaminants are present at high concentration (bulk separations).

In some examples, the electrical current stimulated desorption can include an increase in energy input by electricity. An increase in energy input by electricity has been found able to improve desorption performance more significantly than an increase in current level. However, higher current level is recommended because it can minimize energy loss while passing electricity. In some examples the fused carbon monoliths can desorb CO₂ while only increasing temperature slightly. For example, the electrical current applied to the carbon monoliths can be between about 0.1 amps and about 1 amp at a set voltage of between about 1V and about 100V. In some examples, other current ranges can be applied. The desorption energy, power multiplied by time, can be calculated by measuring the desorption time under constant input power. In some examples, the set voltage can be maintained at about 15V and the current ranges can vary. For example, the current can be between about 0.5 amps and about 1.5 amps, between about 1 amp and about 2 amps, or between about 2 amp and about 3 amps. In some examples, the temperature rise in the carbon monolith is less than 50° C. In other examples, the temperature rise can be less than 20° C., less than 10° C., or less than 5° C. Generally, the adsorption capacity and the process of electrical current stimulated desorption is repeatable. The heating characteristics of the carbon monoliths support regeneration at low voltages and make reuse of the monolith easier and also reduce the energy requirement of the regeneration process.

In some examples, the act 110 of desorbing the component from the carbon monolith can include applying varying frequency microwaves to the carbon monoliths. In some examples, the microwave desorption restores the carbon's active sites available for adsorption. Microwave-induced regeneration allows the saturated carbon monoliths to be rapidly regenerated and provides an economical method to remove contaminants and/or carbon dioxide emitted. In some examples, the microwaves can have a power setting between about 0 and about 6000 Watts, and can also have variable or fixed frequencies. In some examples the frequency can be between about 2000 MHz and about 3000 MHz.

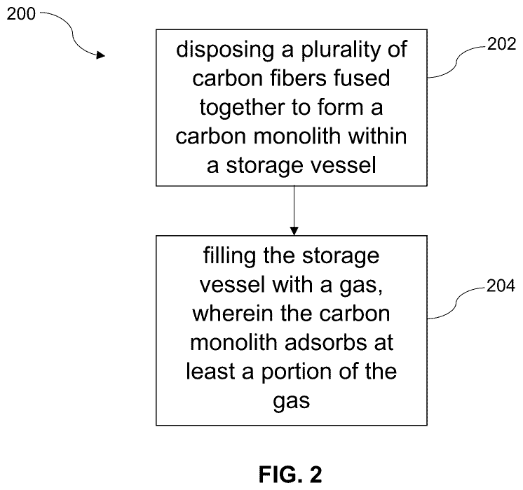

Referring to FIG. 2, in some examples, a method 200 of storing a gas can include an act 202 of disposing a plurality of carbon fibers that are fused together to form a carbon monolith within a storage vessel. The carbon monolith can be formed as described above with the melt blow fibers being fused. In some examples the carbon fibers are activated. Because the carbon monoliths include pore structures and surface chemistry for adsorption of gases the monoliths can be placed within a storage vessel to assist in gas storage. The gas can be stored in a low pressure, low mass, low volume environment that would be much more feasible than bulky on-board pressure tanks in vehicles.

The method 200 can include the act 202 of filling the storage vessel with a gas. The carbon monolith can adsorb at least a portion of the gas. In some examples, the gas can include at least one of hydrogen, natural gas, methane, carbon dioxide, propane, or any other suitable gas. In some examples, other fluids can be stored within the carbon monolith including acids, phenols, beverages, water, amines, benzenes, pharmaceuticals, or other suitable compounds.

Activated carbons present advantages that make them suitable materials for gas storage such as high surface area, large pore volume and light weight. In particular, for the propane and methane storage process they have the benefits of not being sensitive to humid conditions, they tend to have reasonable prices as well as good adsorption properties at atmospheric pressure. Further, the gas storage capacity of the activated carbon monolith can be improved by controlling the pore structures. Since the microporosity of the activated carbon monolith is created by removal of carbon atoms during the activation process, after a certain microporosity volume, further activation is followed by the creation of macropores translating into a less than desirable volume for gas storage and thus a decrease of the packing density. Hence, carbons with high CH4 uptake might result in a lower volumetric storage capacity of methane than some with lower surface area. As such, the carbon monolith can be configured to adsorb a specific element. For example, smaller pores (e.g., about 0.7 nm) are more convenient for hydrogen storage.

The use of the activated carbon monoliths can provide some benefits to the storage. For example, the pressure capacity of the storage vessel can be reduced compared to purely gaseous storage. For example, the storage vessel can include a maximum operating pressure between about 100 psi and about 1000 psi. However, other pressure ranges are available depending on the gaseous component and the volume of the storage vessel. For example, the maximum operating pressure can be between about 100 and about 200 psi, between about 150 and about 250 psi, between about 200 and about 300 psi, between about 250 and about 350 psi, between about 300 and about 400 psi, between about 500 and about 600 psi, between about 600 and about 700 psi, between about 700 and about 800 psi, between about 800 and about 900 psi, or between about 900 and about 1000 psi.

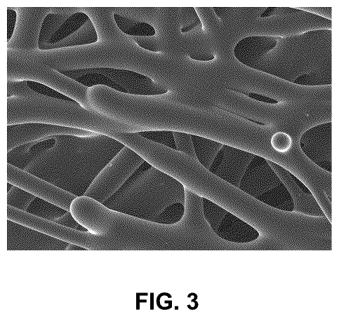

The arrangement of the activated carbon monolith can also provide a potential benefit of a slower gaseous release, which improves the safety of the storage system. For example, the plurality of carbon fibers of the carbon monolith can be randomly oriented. As such the release path of the adsorbed gas can be tortuous and slowed, as well as a more deliberate release of the gas from being bound to the monolith. FIG. 3 illustrates a scanning electron microscope (SEM) image of melt blown carbon fibers from a coal based pitch forming a carbon monolith at 144 times magnification, according to one embodiment of the present disclosure. The plurality of carbon fibers are melt blown carbon fibers fused together at contact points. Further, each carbon fiber of the plurality of carbon fibers can include a longitudinal resistivity of between about 1.5 μΩm and about 20 μΩm. In some examples, electrical conductivity of the fiber can be improved by doping or forming composites. In other examples, removing materials can improve the properties of the activated carbon monoliths. For example, the carbon monolith can be formed without a binder to bind the melt blown carbon fibers. In some examples, the arrangement of the fibers can affect the conductivity of the monolith. For example, as shown in FIG. 3, the carbon fibers fused together to form the carbon monolith are randomly oriented.

As used herein, the term “about” or “substantially” refers to an allowable variance of the term modified by “about” or “substantially” by ±10% or ±5%. Further, the terms “less than,” “or less,” “greater than,” “more than,” or “or more” include, as an endpoint, the value that is modified by the terms “less than,” “or less,” “greater than,” “more than,” or “or more.”

While various aspects and embodiments have been disclosed herein, other aspects and embodiments are contemplated. The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including” and “having” come as used in the specification and claims shall have the same meaning as the term “comprising.”

What is claimed is:

1. A method for separating components of a fluid stream, comprising:
making an activated carbon fiber;
forming a carbon monolith by fusing a plurality of activated carbon fibers together;
disposing the carbon monolith within a fluid stream; and
capturing at least one component of the fluid stream with the carbon monolith.

2. The method of claim 1, wherein making the activated carbon fiber includes a physical activation or a chemical activation, wherein the physical activation comprises pyrolizing the carbon fiber to between about 600° C. and about 900° C. and chemical activation comprises treating the carbon fiber with a chemical activation agent and heating to a temperature of between about 450° C. and about 700° C.

3. The method of claim 2, wherein the chemical activation agent comprises at least one of a phosphoric acid, sulfuric acid, or zinc chloride.

4. The method of claim 1, wherein the carbon monolith is configured to adsorb aqueous greenhouse gases from wastewater.

5. The method of claim 1, wherein the carbon monolith is configured to dehumidify air.

6. The method of claim 1, wherein the carbon monolith is configured to adsorb air contaminants.

7. The method of claim 1, wherein the carbon monolith is configured to adsorb carbon dioxide.

8. The method of claim 1, further comprising desorbing the component from the carbon monolith.

9. The method of claim 8, wherein desorbing the component comprises an electrical current stimulated desorption.

10. The method of claim 9, wherein the electrical current comprises between about 0.1 amp and about 1 amp at a set voltage of between about 1V and about 10V.

11. The method of claim 8, wherein desorbing the component comprises applying varying frequency microwaves to the carbon monoliths.

12. A method of storing a gas comprising:
disposing a plurality of activated carbon fibers fused together to form a carbon monolith within a storage vessel; and
filling the storage vessel with a gas, wherein the carbon monolith adsorbs at least a portion of the gas.

13. The method of claim 12, wherein the plurality of carbon fibers of the carbon monolith are randomly oriented.

14. The method of claim 12, wherein the gas comprises at least one of hydrogen, methane, carbon dioxide, or propane.

15. The method of claim 12, wherein the carbon monolith is configured to adsorb a specific element.

16. The method of claim 12, wherein the storage vessel comprises a maximum allowable operating pressure between about 100 psi and about 1,000 psi.

17. The method of claim 12, wherein the carbon monolith is configured to delay the release rate of the gas from the storage vessel.

18. A carbon monolith comprising:
a plurality of carbon fibers fused together to form the carbon monolith, wherein the plurality of carbon fibers are melt blown carbon fibers fused together at contact points; and
each carbon fiber of the plurality of carbon fibers comprises a longitudinal resistivity of between about 1.5 μΩm and about 20 μΩm.

19. The carbon monolith of claim 18, wherein the carbon monolith does not include a binder to bind the melt blown carbon fibers.

20. The carbon monolith of claim 18, wherein the carbon fibers fused together to form the carbon monolith are randomly oriented.
